(19) United States
(12) Patent Application Publication
(10) Pub. No.: US 2013/0021442 A1
(43) Pub. Date: Jan. 24, 2013

(54) ELECTRONIC CAMERA

(71) Applicant: Masayoshi Okamoto, Daito-shi (JP)

(72) Inventor: Masayoshi Okamoto, Daito-shi (JP)

(73) Assignee: SANYO ELECTRIC CO., LTD., Osaka (JP)

(21) Appl. No.: 13/552,132

(22) Filed: Jul. 18, 2012

(30) Foreign Application Priority Data
Jul. 19, 2011 (JP) 2011-158303

(51) Int. Cl. H04N 13/02

(52) U.S. Cl. 348/46; 348/E13.074

(57) ABSTRACT

An electronic camera includes an imager. An imager repeatedly outputs an image indicating a space captured on an imaging surface. A displayer displays the image outputted from the imager. A superimposer superimposes an index indicating a position of at least a focal point onto the image displayed by the displayer. A position changer changes a position of the index superimposed by the superimposer according to a focus adjusting operation. A setting changer changes a focusing setting in association with the process of the position changer.

### CROSS REFERENCE OF RELATED APPLICATION

The disclosure of Japanese Patent Application No. 2011-158303, which was filed on Jul. 19, 2011, is incorporated herein by reference.

### BACKGROUND OF THE INVENTION

1. Field of the Invention

The present invention relates to an electronic camera, and more particularly, the present invention relates to an electronic camera which superimposes an index indicating predetermined information onto a display image.

2. Description of the Related Art

According to one example of this type of camera, a pseudo three-dimensional space is expressed on a screen by a display of a browser view screen, and a space cursor is displayed to indicate a predetermined region of the pseudo three-dimensional space. Together with the display of the space cursor, various types of information arranged at a predetermined position in the pseudo three-dimensional space are displayed using an icon. When a shutter button is half depressed, information arranged in the space cursor is selected from each information displayed using the icon.

However, in the above described camera, it is described that the icon indicates an imaging condition at the time of photographing when a photographed image is reproduced, however, it is not described that the icon displays an imaging condition of a current time point when performing photographing. Therefore, when an adjustment operation of the imaging condition such as a focusing setting is performed, it is probable that an irrelevant past imaging condition, etc., are displayed, which may deteriorate an operability.

### SUMMARY OF THE INVENTION

An electronic camera according to the present invention, comprises: an imager which repeatedly outputs an image indicating a space captured on an imaging surface; a displayer which displays the image outputted from the imager; a superimposer which superimposes an index indicating a position of at least a focal point onto the image displayed by the displayer; a position changer which changes a position of the index superimposed by the superimposer according to a focus adjusting operation; and a setting changer which changes a focusing setting in association with a process of the position changer.

According to the present invention, an imaging control program, which is recorded on a non-temporary recording medium in order to control an electronic camera including an imager which repeatedly outputs an image indicating a space captured on an imaging surface, causing a processor of the electronic camera to execute: a display step of displaying the image outputted from the imager; a superimposing step of superimposing an index indicating a position of at least a focal point onto the image displayed in the display step; a position changing step of changing a position of the index superimposed in the superimposing step according to a focus adjusting operation; and a setting changing step of changing a focusing setting in association with the process of the position changing step.

According to the present invention, an imaging control method, which is performed by an electronic camera including an imager which repeatedly outputs an image indicating a space captured on an imaging surface, comprises: a display step of displaying the image outputted from the imager; a superimposing step of superimposing an index indicating a position of at least a focal point onto the image displayed in the display step; a position changing step of changing a position of the index superimposed in the superimposing step according to a focus adjusting operation; and a setting changing step of changing a focusing setting in association with the process of the position changing step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one portion of an external appearance of a camera of the embodiment in FIG. 2;

FIG. 4 is an illustrative view showing one example of a scene captured by the embodiment in FIG. 2;

FIG. 5 is an illustrative view showing one example of an image created by the embodiment in FIG. 2;

FIG. 6 is an illustrative view showing one example of a display of a live view image;

FIG. 7 is an illustrative view showing one example of a display of a focus marker;

FIG. 8 is an illustrative view showing another example of the image created by the embodiment in FIG. 2;

FIG. 9 is an illustrative view showing a positional relation in a horizontal direction between the camera of the embodiment in FIG. 2 and a scheduled photograph location;

FIG. 10 is an illustrative view showing a positional relation in a vertical direction between the camera of the embodiment in FIG. 2 and the scheduled photograph location;

FIG. 11 is an illustrative view showing still another example of the image created by the embodiment in FIG. 2;

FIG. 12 is an illustrative view showing a positional relation in a vertical direction between the camera of the embodiment in FIG. 2 and another scheduled photograph location;

FIG. 13 is a flowchart showing one portion of an operation of a CPU applied to the embodiment in FIG. 2;

FIG. 14 is a flowchart showing another portion of the operation of the CPU applied to the embodiment in FIG. 2;

FIG. 15 is a flowchart showing still another portion of the operation of the CPU applied to the embodiment in FIG. 2;

FIG. 16 is a flowchart showing one portion of an operation of a CPU applied to another embodiment of the present invention; and

FIG. 17 is a block diagram showing a configuration of still another embodiment of the present invention.

### DETAILED DESCRIPTION OF THE PREFERRED EMBODIMENTS

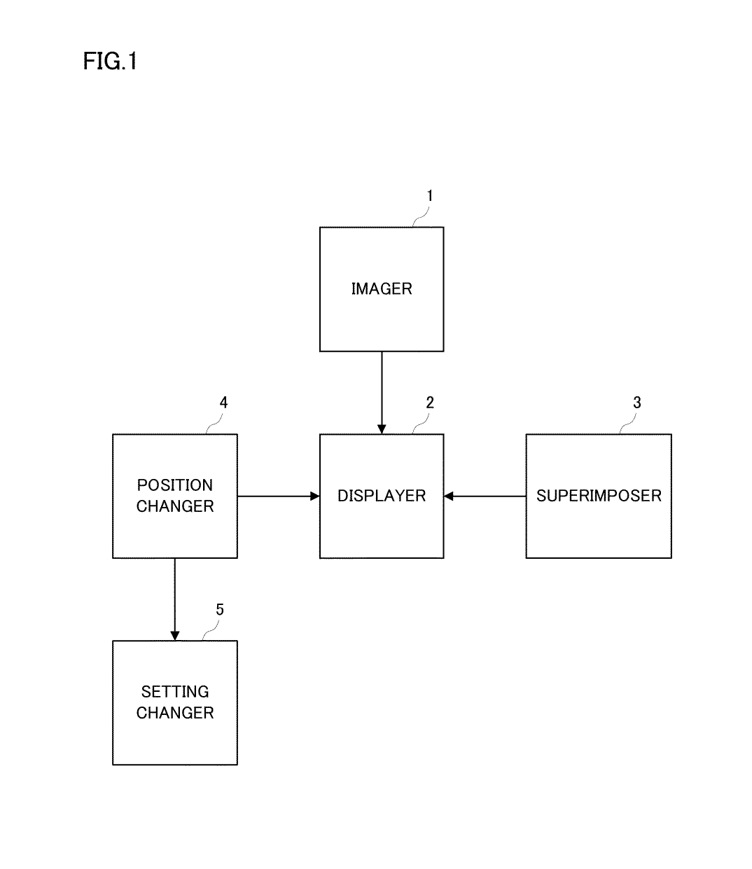

With reference to FIG. 1, an electronic camera according to one embodiment of the present invention is basically configured as follows: An imager 1 repeatedly outputs an image indicating a space captured on an imaging surface. A displayer 2 displays the image outputted from the imager 1. A superimposer 3 superimposes an index indicating a position of at least a focal point onto the image displayed by the displayer 2. A position changer 4 changes a position of the index superimposed by the superimposer 3 according to a focus adjusting operation. A setting changer 5 changes a focusing setting in association with the process of the position changer 4.

The index indicating the position of the focal point is superimposed and displayed on the image indicating the space captured on the imaging surface. The position of the index is changed according to the focus adjusting operation. Furthermore, in association with the change in the position of the index, the focusing setting is changed.

As described above, through the change in the position of the index, it is possible to visually capture the change in the focusing setting. Consequently, it is possible to improve an operability in the focusing setting.

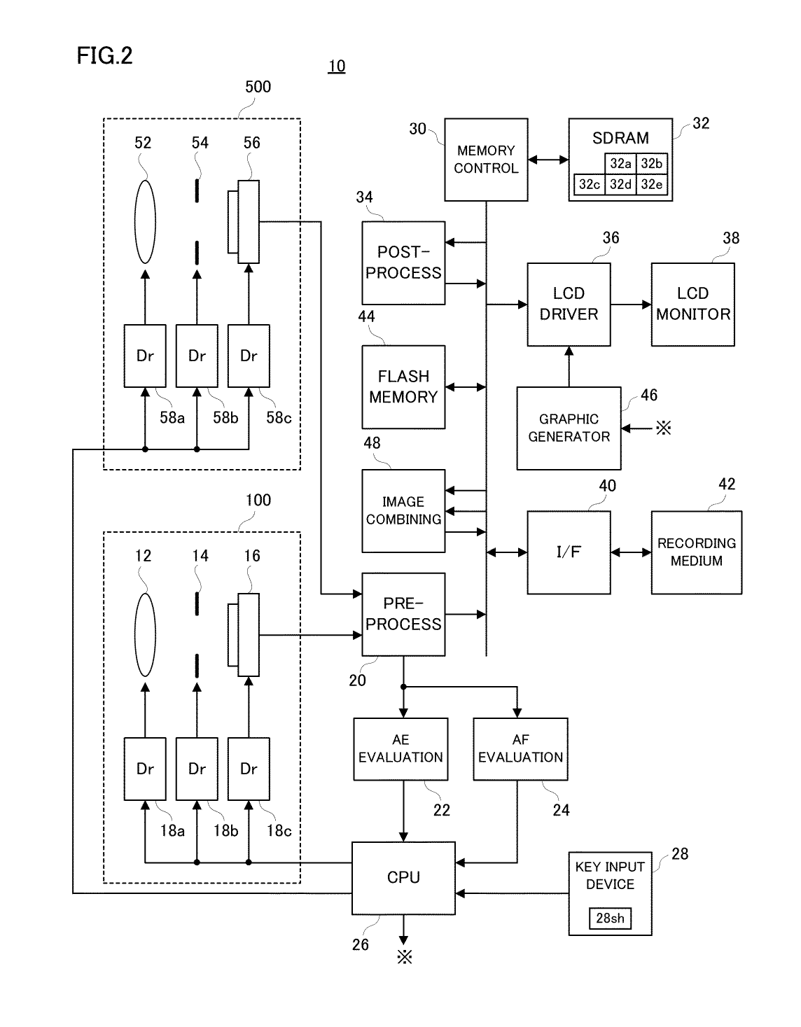

With reference to FIG. 2, a digital camera 10 according to this embodiment includes a focus lens 12 and an aperture unit 14 respectively driven by drivers 18a and 18b. An optical image of a scene that underwent theses members enters, with irradiation, an imaging surface of an image sensor 16 driven by a driver 18c, and is subject to a photoelectric conversion. Furthermore, the focus lens 12, the aperture unit 14, the image sensor 16, and the drivers 18a to 18c configure a first imaging block 100.

Furthermore, the digital camera 10 is provided with a focus lens 52, an aperture unit 54, and an image sensor 56, which are respectively driven by drivers 58a, 58b, and 58c, in order to capture a scene common to a scene captured by the image sensor 16. An optical image that underwent the focus lens 52 and the aperture unit 54 enters, with irradiation, an imaging surface of the image sensor 56, and is subject to a photoelectric conversion. Furthermore, the focus lens 52, the aperture unit 54, the image sensor 56, and the drivers 58a to 58c configure a second imaging block 500.

By these members, charges corresponding to the scene captured by the image sensor 16 and charges corresponding to the scene captured by the image sensor 56 are generated.

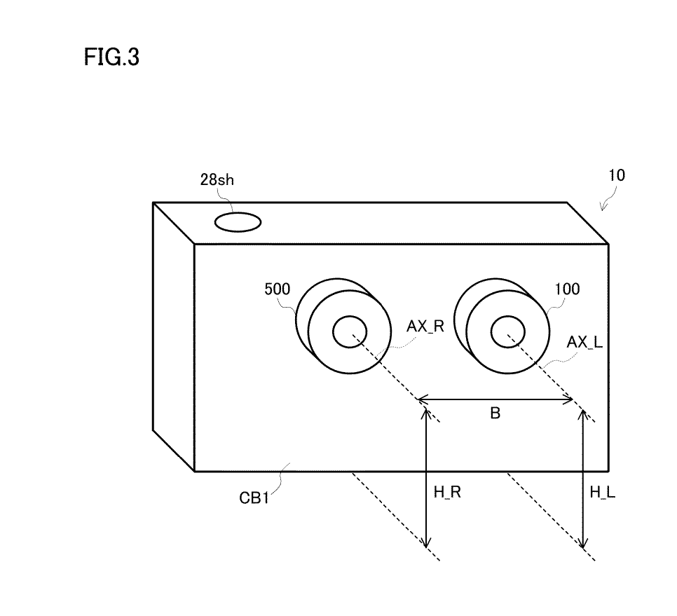

With reference to FIG. 3, the first imaging block 100 and the second imaging block 500 are fixedly provided to a front surface of a housing CB1 of the digital camera 10. The first imaging block 100 is positioned at a left side toward a front of the housing CB1 and the second imaging block 500 is positioned at a right side toward the front of the housing CB1.

The first imaging block 100 and the second imaging block 500 have optical axes AX_L and AX_R respectively, and a distance (=H_L) from a bottom surface of the housing CB1 to the optical axis AX_L coincides with a distance (=H_R) from the bottom surface of the housing CB1 to the optical axis AX_R. Furthermore, an interval (=B) between the optical axes AX_L and AX_R in a horizontal direction is set to about 6 cm in consideration of an interval between both eyes of the human. Moreover, the first imaging block 100 and the second imaging block 500 have a common magnification. Using the optical images that underwent each of the above-described first imaging block 100 and second imaging block 500, a 3D (three dimensional) moving image is displayed in the following manner.

When a power source is applied, in order to perform a moving image taking process, a CPU 26 instructs each of the drivers 18c and 58c to repeat an exposing procedure and a charge reading procedure under an imaging task. The drivers 18c and 58c respectively expose the imaging surfaces of the image sensors 16 and 56 and read out charges, which are generated on the imaging surfaces of the image sensors 16 and 56, in a raster scanning mode, in response to a vertical synchronizing signal Vsync periodically generated from an SG (Signal Generator) not shown. From each of the image sensors 16 and 56, raw image data indicating a scene is repeatedly outputted. Hereinafter, the raw image data outputted from the image sensor 16 is referred to as “first raw image data”, and the raw image data outputted from the image sensor 56 is referred to as “second raw image data”.

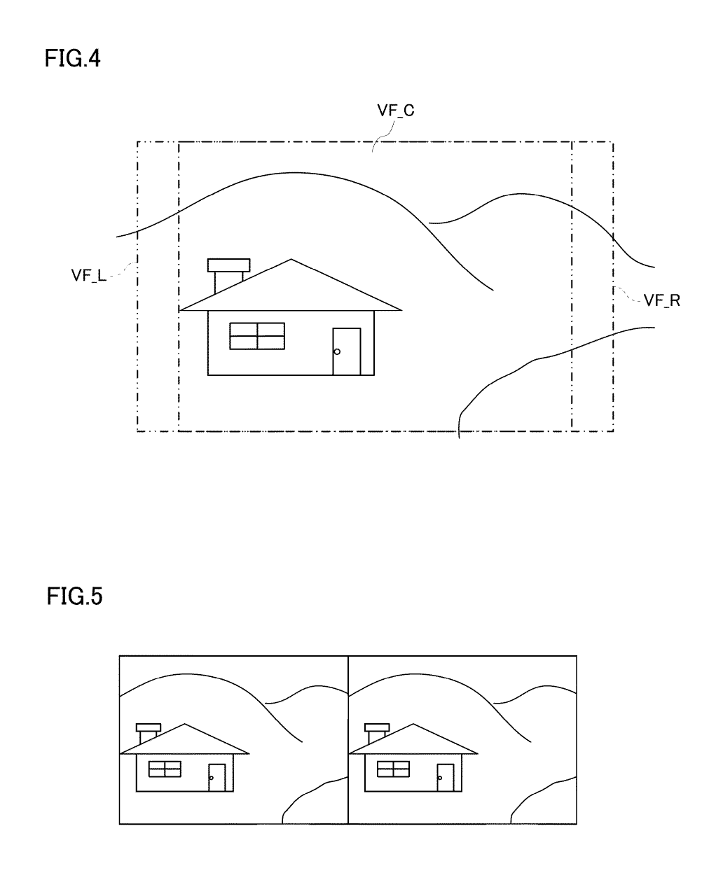

When a scene shown in FIG. 4 is spread in front of a composite camera device 100, the image sensor 16 captures a left field of vision VF_L and the image sensor 56 captures a right field of vision VF_R. Since the distance H_L coincides with the distance H_R, horizontal positions of the left field of vision VF_L and the right field of vision VF_R are slightly shifted from each other; however, vertical positions of the left field of vision VF_L and the right field of vision VF_R coincide with each other. As a result, a common field of vision VF_C captured by both of the image sensors 16 and 56 partially appears in each of the left field of vision VF_L and the right field of vision VF_R.

Returning to FIG. 2, a pre-processing circuit 20 performs processes such as digital clamping, pixel defect correction, and gain control, on the first raw image data outputted from the image sensor 16. The first raw image data on which these processes are performed is written in a first raw image area 32a of an SDRAM 32 through a memory control circuit 30.

Furthermore, the pre-processing circuit 20 performs processes such as the digital clamping, the pixel defect correction, and the gain control, on the second raw image data outputted from the image sensor 56. The second raw image data on which these processes are performed is written in a second raw image area 32b of the SDRAM 32 through the memory control circuit 30.

The memory control circuit 30 designates a cutout area, which corresponds to the common field of vision VF_C, in the first raw image area 32a and the second raw image area 32b. An image combining circuit 48 repeatedly reads out one portion of first raw image data belonging to the cutout area from the first raw image area 32a through the memory control circuit 30, and repeatedly reads out one portion of second raw image data belonging to the cutout area from the second raw image area 32b through the memory control circuit 30.

The reading process from the first raw image area 32a and the reading process from the second raw image area 32b are performed in a parallel manner, and as a result, the first raw image data and the second raw image data of a common frame are simultaneously inputted to the image combining circuit 48. The image combining circuit 48 combines thus-inputted first raw image data and second raw image data to create 3D image data (referring to FIG. 5). The created 3D image data of each frame is written into a 3D image area 32c of the SDRAM 32 through the memory control circuit 30.

An LCD driver 36 repeatedly reads out the 3D image data accommodated in the 3D image area 32c through the memory control circuit 30, and drives an LCD monitor 38 based on the read-out 3D image data. As a result, a real-time moving image (a live view image) indicating the common field of vision VF_C is 3D-displayed on the LCD monitor 38.

When a shutter button 28sh is in a non-operation state, the CPU 26 performs a simple AE process based on an output from an AE evaluating circuit 22 in parallel with the moving image taking process under the imaging task. The simple AE process is performed while giving a priority to an aperture amount, and an exposure time defining an appropriate EV value in cooperation with an aperture amount set in the aperture unit 14 is simply calculated. The calculated exposure time is set to each of the drivers 18c and 58c. As a result, the brightness of the live view image is adjusted moderately. It is noted that, when the power source is applied, the simple AE process is performed with reference to an aperture amount set as a default value.

When it is considered that if focus adjustment based on an auto-focus function is attempted, and then a photo-opportunity is missed, an operator of the digital camera 10 manually performs the focus adjustment in the following manner. Examples of the case in which the photo-opportunity is missed include a case in which the operator waits to photograph a train during traveling and a case in which the operator waits to photograph a quickly moving wild animal.

If the live view image starts to be 3D-displayed, under the imaging task, the CPU 26 requests a graphic generator 46 to display a focus marker MK with reference to a current position of each of the focus lenses 12 and 52 and a current aperture amount. The graphic generator 46 outputs graphic information indicating the focus marker MK toward the LCD driver 36. As a result, the focus marker MK is superimposed and displayed on the live view image.

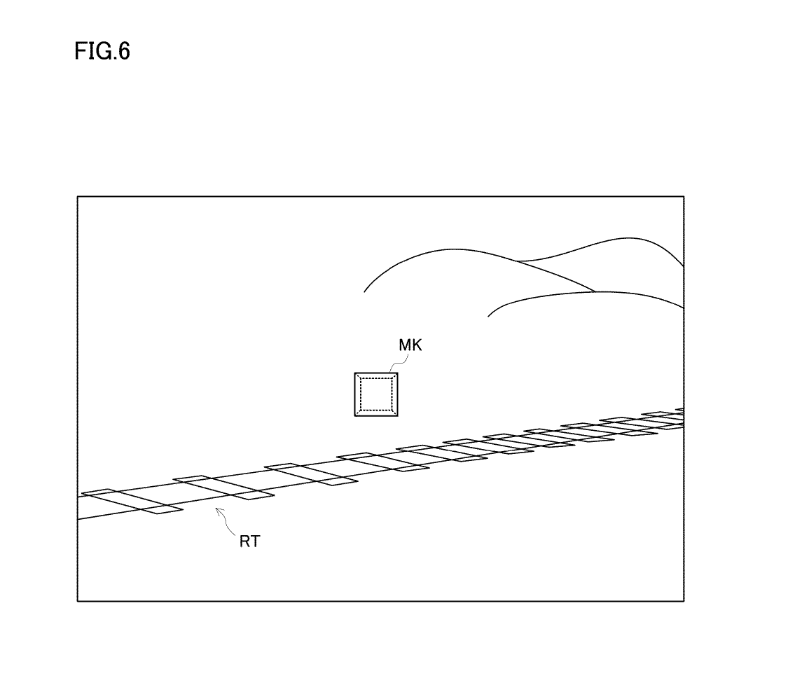

With reference to FIG. 6, the focus marker MK is prepared in the form of a rectangular parallelepiped, and is displayed at a center of the live view image when the power source is applied. Meanwhile, based on the referenced position of each of the focus lenses 12 and 52 and the referenced aperture amount, a focus position and a depth of field are respectively calculated. The focus marker MK is displayed based on a result of the calculation, and a display position and a depth of the focus marker MK indicate a current focus position and a depth of field, respectively.

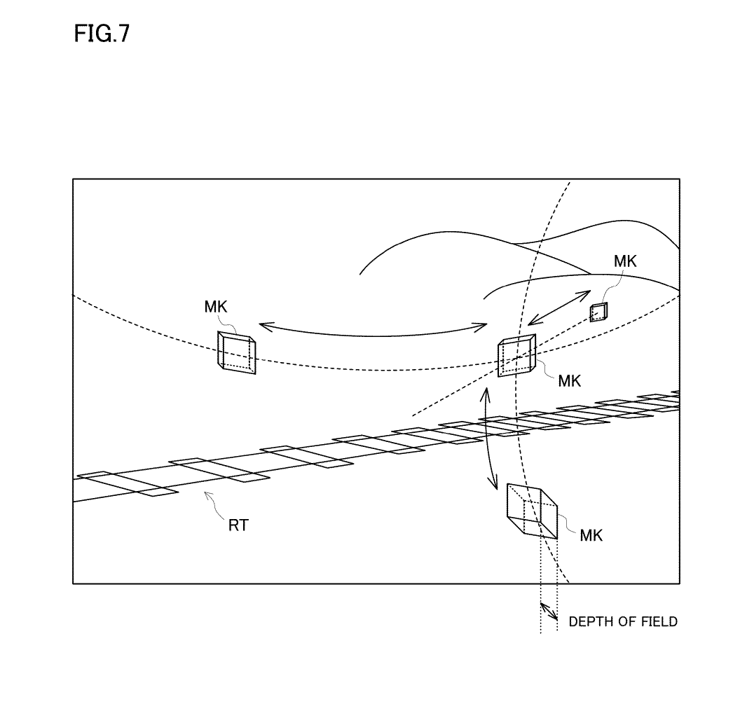

With reference to FIG. 7, the focus marker MK is moved in the 3D-displayed live view image according to a changing operation of the focus position by the operator. Furthermore, a size of the depth of the focus marker MK is changed according to a changing operation of the depth of field by the operator.

If the position of each of the focus lenses 12 and 52 is changed by the changing operation of the focus position by the operator, the focus marker MK is moved to a depth direction of the live view image. Consequently, if the focus position is set at a far location, the display position of the focus marker MK is changed to a depth of the live view image and a display size of the focus marker MK becomes small. On the other hand, if the focus position is set at a near location, the display position of the focus marker MK is changed to a front of the live view image and the display size of the focus marker MK becomes large.

If a changing operation of the depth of field is performed through a key input device 28, the CPU 26 instructs a driver 18b to adjust the aperture amount of the aperture unit 14. If the depth of field is changed by a change in the aperture amount, a shape of the focus marker MK is contracted and expanded in the depth direction. In this way, a range occupied by the focus marker MK indicates a focusing range. Consequently, if the depth of field is shallowly set, the depth of the focus marker MK becomes short. On the other hand, if the depth of field is deeply set, the depth of the focus marker MK becomes long.

With reference to such display position or depth of the focus marker MK, the operator adjusts the focus position or the depth of field, respectively. Furthermore, as a result of the operation of the key input device 28 by the operator, the focus marker MK is moved in a horizontal direction or a vertical direction, as well. Therefore, it is sufficient if the operator moves the focus marker MK to a position at which an object is desirably captured, and after the movement, performs the changing operation of the focus position or the depth of field. It is noted that the focus marker MK is superimposed onto the 3D-displayed live view image, and thus, the focus marker MK is displayed in a direction changed according to the display position after the movement.

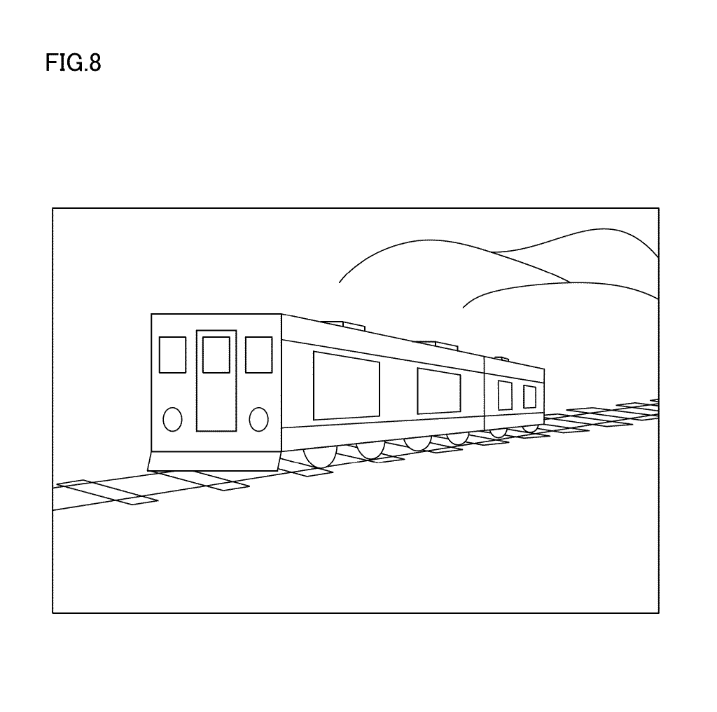

When the operator waits to photograph a train during traveling as with an image shown in FIG. 8, the operator performs a focus adjustment in the following manner.

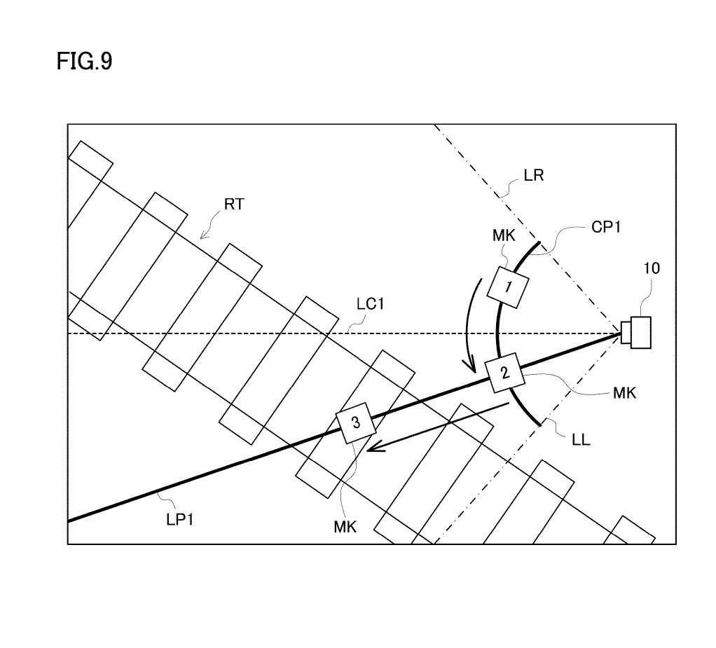

FIG. 9 is an illustrative view showing a positional relation in a horizontal direction between the digital camera 10 and a track RT on which a train passes. When the focus lens 12 is to be obliquely directed to a travel direction of the train as shown in FIG. 8 and a front of the train is to be captured at a left side of an angle of view, with reference to FIG. 9, the operator moves the focus marker MK between a straight line LC1 indicating a center of the angle of view of a cutout area and a straight line LL indicating a left end of the angle of view, and then adjusts the focus position.

For example, when the focus marker MK is in a position indicated by “1” between the straight line LC1 and a straight line LR indicating a right end of the angle of view of the cutout area, the operator moves the focus marker MK in a left direction by operating the key input device 28. According to this operation, the focus marker MK is moved on a curved line CP1 indicating a position at a distance equal to that between the position indicated by “1” and the focus lens 12.

In this way, if the focus marker MK is moved to a position indicated by “2”, the operator performs the changing operation of the focus position. According to this operation, the focus marker MK is moved on a straight line LP1 linking the position indicated by “2” to the focus lens 12.

The position indicated by “2” is at a more proximity side than the track RT, and therefore, the operator moves the focus lens 12 to an infinity side by the changing operation of the focus position with reference to the display position of the focus marker MK. Furthermore, when the focus marker MK reaches a position indicated by “3” at a center of the track RT, the operator determines that the focus position is changed to a target position, and completes the changing operation of the focus position.

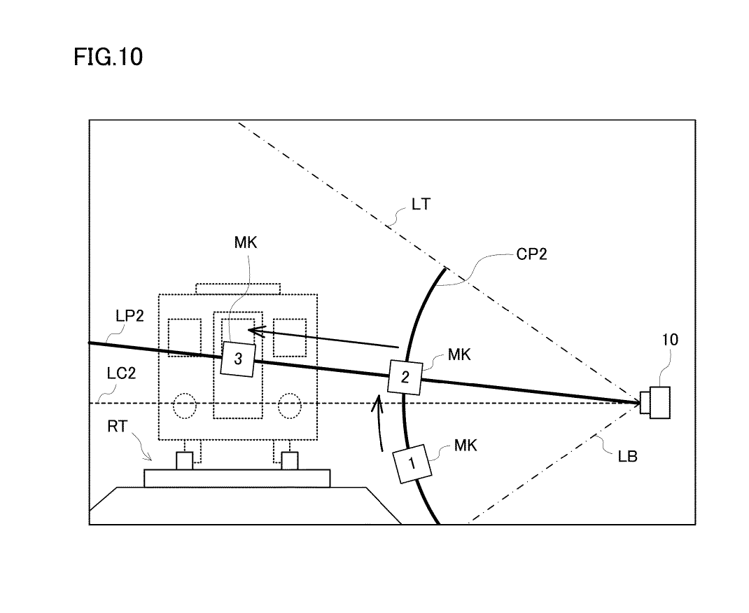

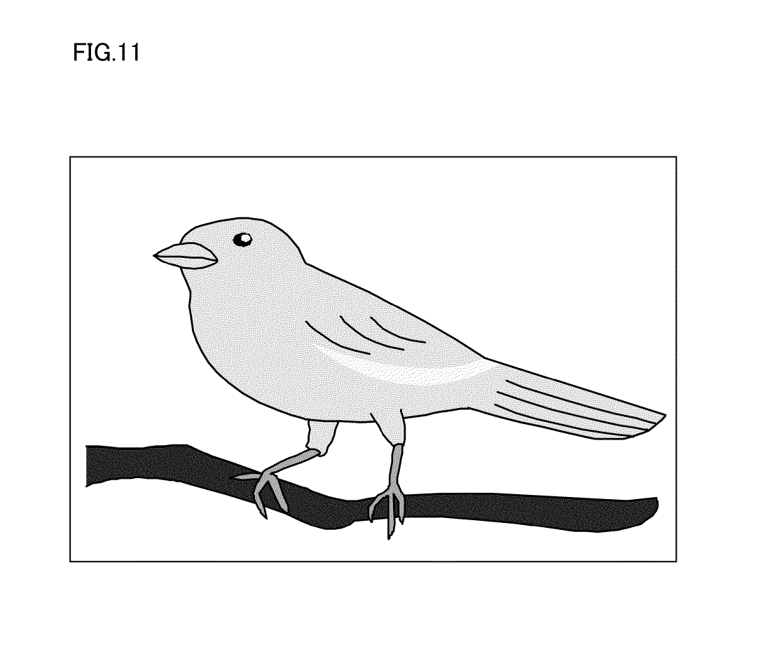

FIG. 10 is an illustrative view showing a positional relation in a vertical direction between the digital camera 10 and the track RT on which the train passes. When the front of the train is to be captured at an upper side of the angle of view as shown in FIG. 8, with reference to FIG. 10, the operator moves the focus marker MK between a straight line LC2 indicating a center of the angle of view of the cutout area and a straight line LT indicating an upper end of the angle of view, and then adjusts the focus position.

When the focus marker MK is in a position indicated by “1” between the straight line LC2 and a straight line LB indicating a lower end of the angle of view of the cutout area, the operator moves the focus marker MK in an upper direction by operating the key input device 28. According to this operation, the focus marker MK is moved on a curved line CP2 indicating a position at a distance equal to that between the position indicated by “1” and the focus lens 12.

In this way, if the focus marker MK is moved to a position indicated by “2”, the operator performs the changing operation of the focus position. According to this operation, the focus marker MK is moved on a straight line LP2 linking the position indicated by “2” to the focus lens 12.

The position indicated by “2” is at a more proximity side than the track RT, and therefore, the operator moves the focus lens 12 to an infinity side by the changing operation of the focus position with reference to the display position of the focus marker MK. Furthermore, when the focus marker MK reaches a position indicated by “3” at a center of the track RT, the operator determines that the focus position is changed to a target position, and completes the changing operation of the focus position.

When waiting to photograph a bird perched on a tree branch as with an image shown in FIG. 11, the operator performs the focus adjustment in the following manner.

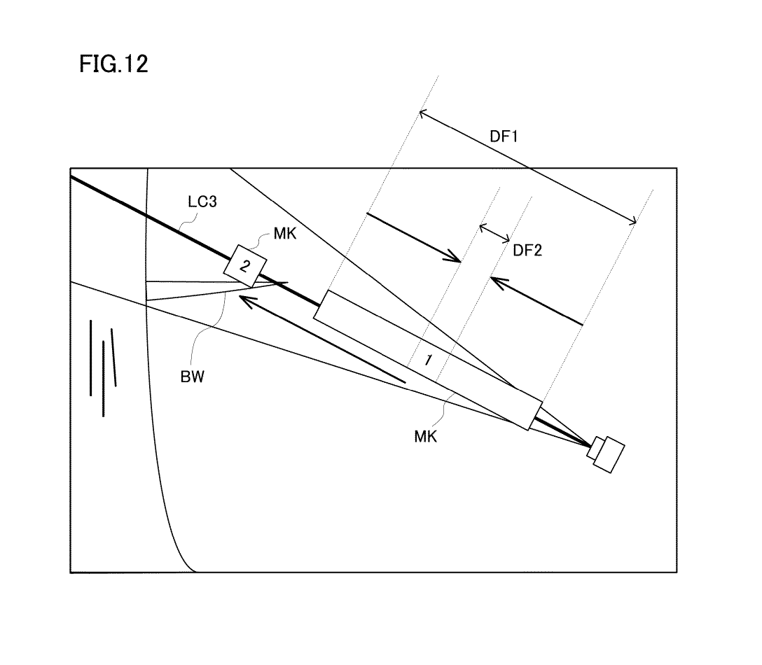

FIG. 12 is an illustrative view showing a positional relation in the vertical direction between the digital camera 10 and a tree branch BW. When focusing the bird perched on the tree branch BW, with reference to FIG. 12, the operator performs the changing operation of the depth of field and adjusts the depth of field based on a size of the bird. Furthermore, when capturing the bird at a center of the angle of view, with reference to FIG. 12, the operator moves the focus marker MK to a straight line LC3 indicating a center of the angle of view of the cutout area, and then adjusts the focus position.

For example, when the depth of the focus marker MK indicates a depth of field DF1, the operator performs a changing operation of the aperture amount, thereby changing a depth of field to a depth of field DF2 based on the size of the bird.

Furthermore, the operator performs the changing operation of the focus position. According to this operation, the focus marker MK moves on the straight line LC3. A position indicated by “1” is at a more proximity side than the tree branch BW, and therefore, the operator moves the focus lens 12 to an infinity side by the changing operation of the focus position with reference to the display position of the focus marker MK. Furthermore, when the focus marker MK reaches a position indicated by “2” on the tree branch BW, the operator determines that the focus position is changed to a target position, and completes the changing operation of the focus position.

In this way, if the changing operation of the focus position or the depth of field is performed and then the shutter button 28sh is half depressed, the CPU 26 performs a strict AE process based on the output of the AE evaluating circuit 22. The strict AE process is performed while giving a priority to the aperture amount, and the exposure time defining the appropriate EV value is strictly calculated according to the aperture amount set in the aperture unit 14. The calculated exposure time is set to each of the drivers 18c and 58c. As a result, the brightness of the live view image is adjusted strictly.

If the shutter button 28sh is fully pressed, the CPU 26 performs a still image taking process and a 3D recording process of each of the first imaging block 100 and the second imaging block 500 under the imaging task. One frame of the first raw image data and one frame of the second raw image data at the time point at which the shutter button 28sh is fully pressed are respectively taken in a first still image area 32d of the SDRAM 32 and a second still image area 32e of the SDRAM 32 by the still image fetching process.

Furthermore, the 3D recording process is performed, so that one still image file having a format corresponding to a recording of a 3D still image is created in a recording medium 42. The taken first raw image data and second raw image data are recorded in the newly created still image file through the recording process together with an identification code indicating the accommodation of the 3D image, a method of arranging two images, a distance between the focus lens 12 and the focus lens 52, and the like.

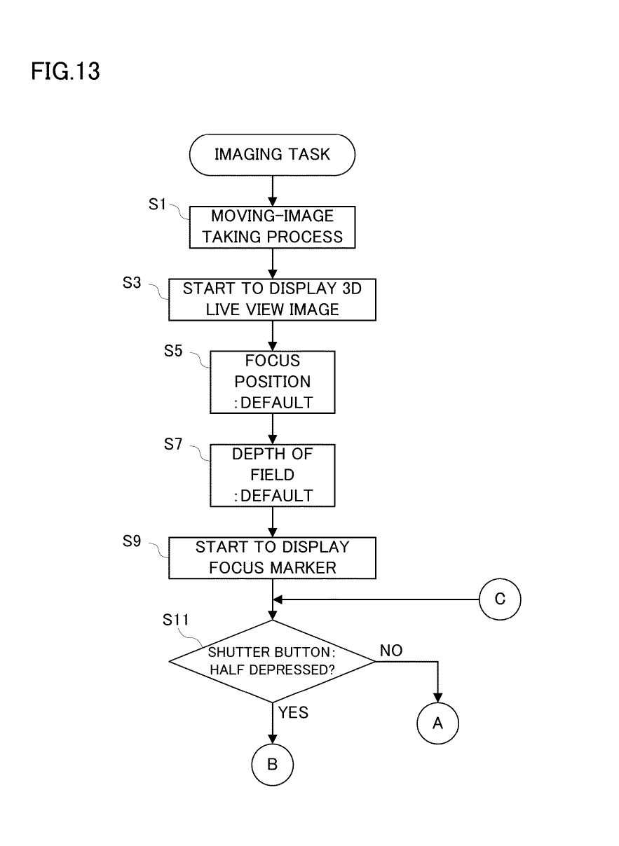

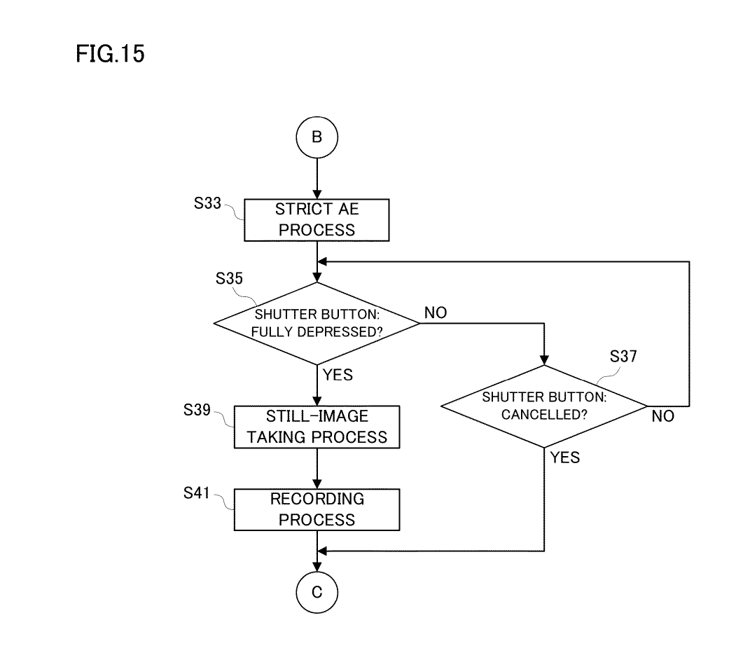

The CPU 26 performs a plurality of tasks including imaging tasks shown in FIGS. 13 to 15 in a parallel manner. It is noted that, a control program corresponding to these tasks is stored in a flash memory 44.

With reference to FIG. 13, in a step S1, the moving image taking process is performed. As a result, the first raw image data is taken from the first imaging block 100 and the second raw image data is taken from the second imaging block 500. In a step S3, the image combining circuit 48 is instructed to combine the two taken images with each other, and instructs the LCD driver 36 to perform image display based on the created 3D image data. As a result, a 3D live view image starts to be displayed.

In a step S5, the drivers 18a and 58a are instructed to move the focus lenses 12 and 52 to default positions. As a result, the focus positions are set to the default positions. In a step S7, the driver 18b is instructed to adjust the aperture amount of the aperture unit 14 to a default value. As a result, the depth of field is set to the default value.

In a step S9, the graphic generator 46 is requested to display the focus marker MK with reference to the current position of each of the focus lenses 12 and 52 and the aperture amount. As a result, the focus marker MK is superimposed and displayed on the live view image.

In a step S11, it is determined whether or not the shutter button 28sh is half depressed, and if a determined result is YES, the process proceeds to a step S33 while if the determined result is NO, the process proceeds to a step S13.

In the step S13, the simple AE process is executed. The aperture amount defining the appropriate EV value calculated by the simple AE process is set to each of the drivers 18b and 58b. Furthermore, the exposure time defining the appropriate EV value calculated by the simple AE process is set in each of the drivers 18c and 58c. As a result, the brightness of the live view image is adjusted moderately.

In a step S15, it is determined whether or not the changing operation of the focus position is performed, and if a determined result is NO, the process proceeds to a step S21 while if the determined result is YES, the focus position is changed in a step S17 by a change in the position of each of the focus lenses 12 and 52.

In a step S19, the focus marker MK is moved in the depth direction of the live view image according to the change in the focus position. If the focus position is set at a far location, the display position of the focus marker MK is changed to the depth of the live view image and the display size of the focus marker MK becomes small. On the other hand, if the focus position is set at a near location, the display position of the focus marker MK is changed to a front of the live view image and the display size of the focus marker MK becomes large. Upon completion of the process in the step S19, the process returns to the step S11.

In the step S21, it is determined whether or not the changing operation of the depth of field is performed, and if a determined result is NO, the process proceeds to a step S27 while if the determined result is YES, the process instructs the driver 18b to adjust the aperture amount of the aperture unit 14 in a step S23. As a result, the depth of field is changed by a change in the aperture amount.

In a step S25, the shape of the focus marker MK is expanded and shrunk in the depth direction according to the change in the depth of field. If the depth of field is shallowly set by decreasing the aperture amount, the depth of the focus marker MK becomes short. On the other hand, if the depth of field is deeply set by increasing the aperture amount, the depth of the focus marker MK becomes long. Upon completion of the process in the step S25, the process returns to the step S11.

In the step S27, it is determined whether or not a movement operation of the focus marker MK is performed, and if a determined result is NO, the process returns to the step S11 while if the determined result is YES, the process proceeds to a step S29. In the step S29, the display position of the focus marker MK is changed in the horizontal direction or the vertical direction according to the movement operation of the focus marker MK. In a step S31, a direction of the focus marker MK is changed according to the moved display position of the focus marker MK. Upon completion of the process in the step S31, the process returns to the step S11.

In the step S33, the strict AE process is performed. The aperture amount defining an optimal EV value calculated by the strict AE process is set to each of the drivers 18b and 58b. Furthermore, an exposure time defining the calculated optimal EV value is set to each of the drivers 18c and 58c. As a result, the brightness of the live view image is adjusted strictly.

In a step S35, it is determined whether or not the shutter button 28sh is fully pressed, and if a determined result is YES, the process proceeds to a step S39 while if the determined result is NO, it is determined whether or not the shutter button 28sh is released in a step S37. If a determined result in the step S37 is No, the process returns to the step S35 while if the determined result in the step S37 is YES, the process returns to the step S11.

In the step S39, the still image taking process of each of the first imaging block 100 and the second imaging block 500 is executed. As a result, one frame of the first raw image data and one frame of the second raw image data at the time point at which the shutter button 28sh is fully depressed are taken in the first still image area 32d and the second still image area 32e, respectively, through the still image taking processes.

In a step S41, the 3D recording process is executed. As a result, one still image file having a format corresponding to the recording of the 3D still image is created in the recording medium 42. The taken first raw image data and second raw image data are recorded in the newly created still image file through the recording process together with an identification code indicating the accommodation of the 3D image, a method of arranging two images, a distance between the focus lens 12 and the focus lens 52, and the like. Upon completion of the process in the step S41, the process returns to the step S11.

As understood from the above-described description, the image sensors 16 and 56 repeatedly output images indicating spaces taken on the imaging surfaces thereof. The LCD driver 36, the LCD monitor 38, the image combining circuit, and the CPU 26 display the images outputted from the image sensors 16 and 56. The graphic generator 46 and the CPU 26 superimpose an index indicating the position of at least the focal point onto the displayed images. The CPU 26 changes the position of the superimposed index according to the focus adjusting operation, and changes the focusing setting in association with the position changing process.

The index indicating the position of the focal point is superimposed and displayed on the image indicating the space captured on the imaging surface. The position of the index is changed according to the focus adjusting operation. Furthermore, in association with the change in the position of the index, the focusing setting is changed.

As described above, through the change in the position of the index, it is possible to visually capture the change in the focusing setting. Consequently, it is possible to improve an operability in the focusing setting.

It is noted that, in this embodiment, using the digital camera 10, the focus marker MK is displayed on the LCD monitor 38. However, binoculars provided with a photographing device may also be used In this case, half mirrors and projecting devices are provided in each of tubes of the binoculars, and the focus marker MK is projected toward the half mirrors from the respective projecting devices. As a result, it is sufficient if an optical image taken in each of the tubes and having transmitted the half mirrors and the focus marker MK reflected to the respective half mirrors are superimposed and viewed by an operator.

Furthermore, in this embodiment, whenever the changing operation of the focus position is performed, the position of each of the focus lenses 12 and 52 is changed, resulting in the change in the display position of the focus marker MK. Furthermore, whenever the changing operation of the depth of field is performed, the aperture amount of the aperture unit 14 is changed, resulting in the change in the depth of the focus marker MK.

However, the display position of the focus marker MK may be changed when the changing operation of the focus position is performed, and then the position of each of the focus lenses 12 and 52 may be changed when a focus determination operation is performed, resulting in the change in the focus position. Furthermore, the depth of the focus marker MK may be changed when the changing operation of the depth of field is performed, and then the aperture amount of the aperture unit 14 may be changed when the focus determination operation is performed, resulting in the change in the depth of field. In these cases, the half-pressing operation of the shutter button 28sh may be regarded as the focus determination operation.

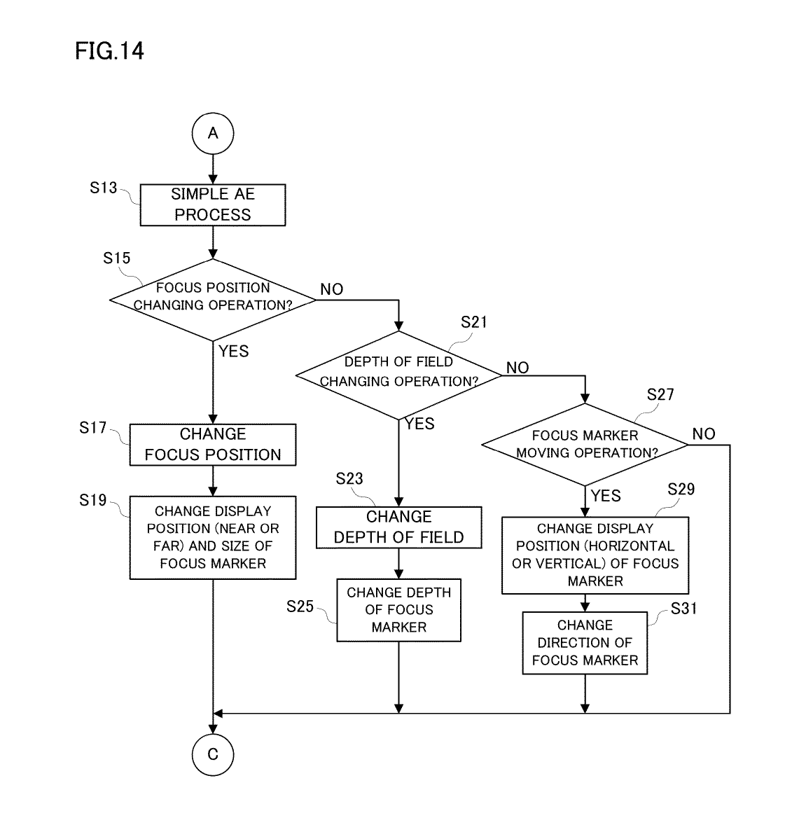

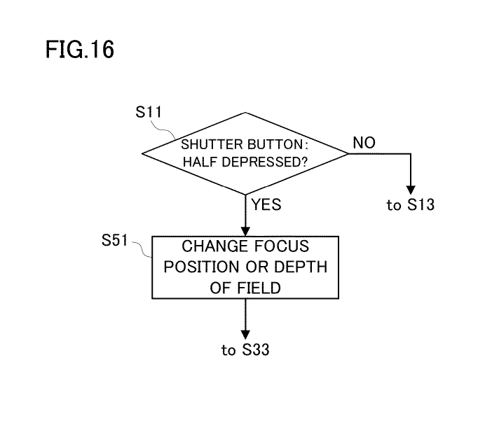

Furthermore, in these cases, instead of the step S17 and the step S23 in FIG. 14, it is sufficient if a step S51 in FIG. 16 is performed before the step S33 when the determined result of the step S11 is YES. In the step S51, the positions of the focus lenses 12 and 52 or the aperture amount of the aperture unit 14 are respectively changed according to the changing operation of the focus position determined in the step S15 or the changing operation of the depth of field determined in the step S21. As a result, the focus position or the depth of field is changed.

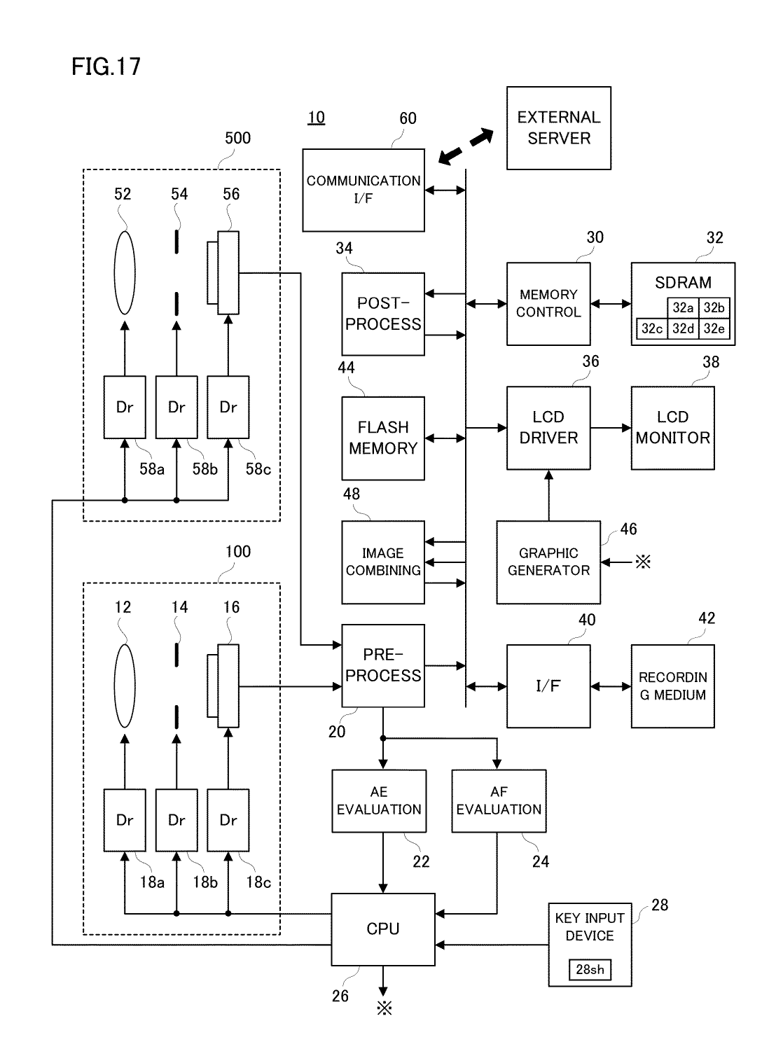

Furthermore, in this embodiment, a multi-task OS and the control program corresponding to a plurality of tasks performed by the multi-task OS are stored in the flash memory 44 in advance. However, a communication I/F 60 for a connection to an external server may be provided in the digital camera 10 in the manner shown in FIG. 17, a partial control program may be prepared in the flash memory 44 as an internal control program from the beginning, and another partial control program may be acquired as an external control program from an external server. In this case, the above-described operations are implemented by the cooperation of the internal control program and the external control program.

Furthermore, in this embodiment, the processes performed by the CPU 26 are divided into a plurality of tasks including the imaging tasks shown in FIG. 13 to FIG. 15. However, these tasks may be further divided into a plurality of smaller tasks, and furthermore, one portion of the plurality of the divided smaller tasks may be integrated with other tasks. Furthermore, when a transfer task is divided into a plurality of smaller tasks, the whole or one portion of the transfer task may be acquired from an external server.

Moreover, in this embodiment, using the images taken in each of the first imaging block 100 and the second imaging block 500, the 3D still image is recorded. However, using the image taken in any one of the first imaging block 100 and the second imaging block 500, a 2D still image may be recorded. Furthermore, this embodiment is described using a digital still camera. However, the present invention can be applied to a digital video camera, a cellular phone, a smart phone, and the like.

Although the present invention has been described and illustrated in detail, it is clearly understood that the same is by way of illustration and example only and is not to be taken by way of limitation, and the spirit and scope of the present invention being limited only by the terms of the appended claims.

What is claimed is:

1. An electronic camera, comprising:
an imager which repeatedly outputs an image indicating a space captured on an imaging surface;
a displayer which displays the image outputted from said imager;
a superimposer which superimposes an index indicating a position of at least a focal point onto the image displayed by said displayer;
a position changer which changes a position of the index superimposed by said superimposer according to a focus adjusting operation; and
a setting changer which changes a focusing setting in association with the process of said position changer.

2. An electronic camera according to claim 1, wherein said displayer includes a creator which creates a three dimensional image based on the image outputted from said imager; and a three dimensional displayer which displays the three dimensional image created by said creator.

3. An electronic camera according to claim 1, wherein said setting changer performs a setting changing process whenever a position changing process of said position changer is performed.

4. An electronic camera according to claim 1, further comprising an acceptor which accepts a focus determination operation in association with the process of said position changer, wherein said setting changer performs the setting changing process after the focus determination operation is accepted by said acceptor.

5. An electronic camera according to claim 1, further comprising:
a shape changer which changes a shape of the index superimposed by said superimposer according to an aperture amount adjusting operation; and
an aperture setting changer which changes an aperture setting in association with the process of said shape changer.

6. Binoculars, comprising the electronic camera according to claim 1.

7. An imaging control program, which is recorded on a non-transitory recording medium in order to control an electronic camera provided with an imager which repeatedly outputs an image indicating a space captured on an imaging surface, causing a processor of the electronic camera to execute the steps comprising:
a display step of displaying the image outputted from said imager;
a superimposing step of superimposing an index indicating a position of at least a focal point onto the image displayed in said display step;
a position changing step of changing a position of the index superimposed in said superimposing step according to a focus adjusting operation; and
a setting changing step of changing a focusing setting in association with the process of said position changing step.

8. An imaging control method, which is performed by an electronic camera provided with an imager which repeatedly outputs an image indicating a space captured on an imaging surface, comprising:
a display step of displaying the image outputted from said imager;
a superimposing step of superimposing an index indicating a position of at least a focal point onto the image displayed in said display step;
a position changing step of changing a position of the index superimposed in said superimposing step according to a focus adjusting operation; and
a setting changing step of changing a focusing setting in association with the process of said position changing step.
